(19) United States
(12) Patent Application Publication
(10) Pub. No.: US 2014/0312140 A1
(43) Pub. Date: Oct. 23, 2014

(54) Non-Parabolic Stream Generation

(71) Applicants: Mark Fuller, Sun Valley, CA (US); Jim Doyle, Sun Valley, CA (US); Woody Knapp, Sun Valley, CA (US)

(72) Inventors: Mark Fuller, Sun Valley, CA (US); Jim Doyle, Sun Valley, CA (US); Woody Knapp, Sun Valley, CA (US)

(21) Appl. No.: 14/214,514

(22) Filed: Mar. 14, 2014

Related U.S. Application Data
(60) Provisional application No. 61/801,073, filed on Mar. 15, 2013.

(51) Int. Cl. B05B 17/08

(52) U.S. Cl. CPC B05B 17/08
USPC 239/22

(57) ABSTRACT

A water delivery device that produces non-parabolic water forms is described. The water form's appearance may be created by altering the amount of water pressure and movement of the nozzle as the water exits the device.

### CROSS REFERENCE TO RELATED APPLICATION

The application claims the benefit of U.S. Provisional Application No. 61/801,073, filed Mar. 15, 2013, the contents of which are incorporated herein by reference.

### FIELD OF THE INVENTION

The present invention generally relates to water displays, including displays where streams of water are altered from their parabolic trajectory to assume unique appearances, such as those associated with a zero or negative horizontal velocity component.

### BACKGROUND OF THE INVENTION

Various water displays and devices that provide visual water effects currently exist. Oftentimes, parabolic laminar streams may be used in water displays to create water streams that travel through the air on a parabolic trajectory. The use of parabolic streams may limit the visual effects provided by the water display in that all parabolas have the same general shape. Accordingly, there is a need for innovative techniques in which non-parabolic streams of water may be created and used in displays to provide a wider range of visual effects.

### SUMMARY OF THE INVENTION

In an aspect of the invention, streams of water that are shot out of a water delivery device and that may otherwise travel in a parabolic trajectory, are disrupted to provide unique visual effects associated with non-parabolic streams of water. These may include separating a water stream into segments, which segments may then appear to flip forward or backwards. These visual effects also include a stream of water that resembles a slack rope tied to a pole, when one oscillates the untied end. These visual effects also include water streams resembling waves, rotating short cylinders or closed loops.

In another aspect of the invention, several factors may be used to create unique non-parabolic visual effects. For example, the trajectory of a water stream may be affected by a change in water pressure or flow. The trajectory may also be affected by movements of the nozzle or other water delivery device that is used to shoot the water into the air. The speed at which flow or nozzle direction may be made and/or the sequence in which these changes are made may result in unique non-parabolic visual effects.

### BRIEF DESCRIPTION OF THE DRAWINGS

FIG. 1 shows a non-parabolic laminar stream in the shape of a wave or slack rope.

FIGS. 2A-2D show a sequence of pictures of a portion of a non-parabolic laminar stream rotating through the air appearing to do a back flip.

FIG. 3 is a side view of a non-parabolic laminar stream in the shape of a backward C.

### DETAILED DESCRIPTION OF THE PREFERRED EMBODIMENTS

The visual non-parabolic water display effects of the current invention are now described with reference to the figures. Where the same or similar components appear in more than one figure, they are identified by the same reference numeral. The invention is described herein with reference to water. However, other liquids and combinations thereof are within the scope of the invention.

If a laminar stream of water is shot upward into the air out of a water delivery device, the stream will generally follow a parabolic trajectory. And if the water stream exit pressure is gradually reduced or increased, the parabolic trajectory may shrink or grow. However, if the exit pressure of volumetric flow is changed quickly, however, various segments of the laminar parabolic stream will be following different trajectories. This is because the stream is not an actual, solid form, but is instead a series of water particles adjacent to one another, with each having its own independent trajectory other than the forces of cohesion. In other words, the water stream will be altered from its previous parabolic trajectory.

Though an abrupt change in pressure may alter the water stream and cause different segments of the stream to follow different trajectories, the abrupt change is not truly instantaneous, so the various segments of the water stream may remain connected by the water particles emitted during the pressure transition. This may result in a non-parabolic water stream visual effect of the current invention that resembles a wave or slack rope.

Besides abrupt changes in water pressure, a parabolic water stream may also be disrupted by a change in the direction of the water delivery device or nozzle that shoots the water into the air. In fact, abrupt changes in nozzle direction may significantly disrupt a previously parabolic water stream.

According to the current invention, unique non-parabolic visual effects may be achieved by the interplay of the water pressure and nozzle direction factors. To this end, the visual effects provided by the current invention may occur by quickly varying the pressure at which the stream is ejected from nozzle 30 and/or quickly pivoting the nozzle 30 so that the direction of the ejected stream is abruptly changed.

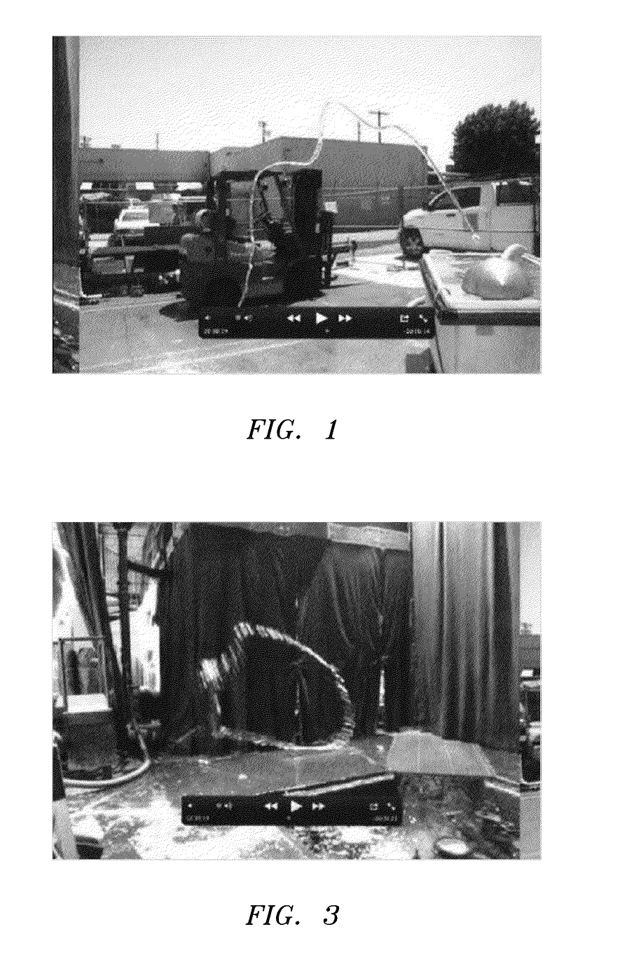

FIG. 1 shows a unique non-parabolic water stream in accordance with the current invention. This wave or slack rope appearance may be achieved by quickly changing the nozzle direction and the wave configuration may be enhanced by also varying water pressure. To this end, rapidly raising and lowering the nozzle may provide the different segments of the slack rope effect. More specifically, faster pivoting of nozzle 30 may likely produce a non-parabolic stream with a short distance between the wave crests (high frequency), while slower pivoting of nozzle 30 may likely produce a non-parabolic stream with a longer distance between the wave crests (low frequency).

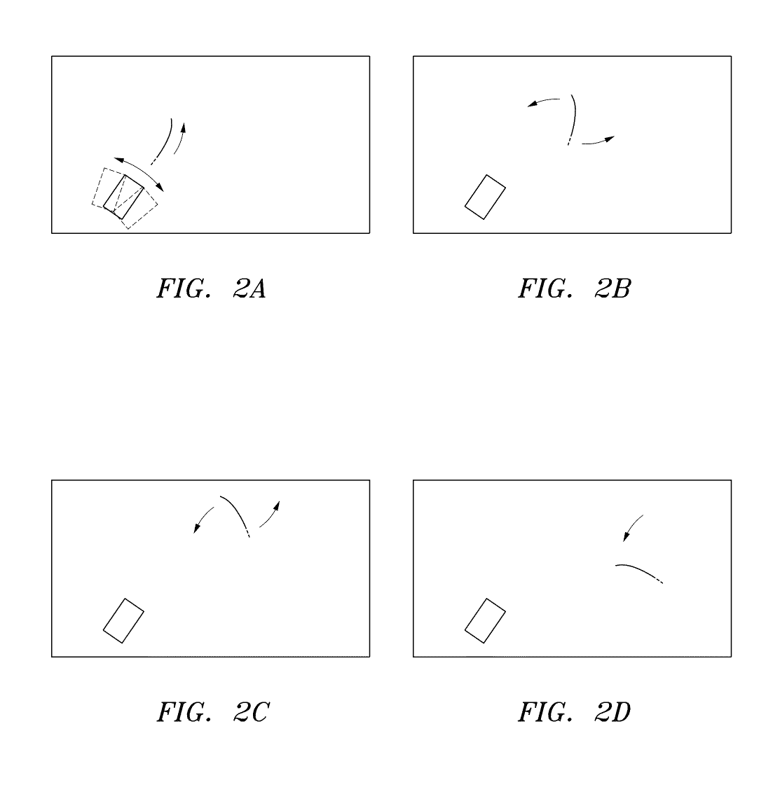

FIGS. 2A-2D show another unique non-parabolic water stream visual effect involving a segment of a water stream doing a back flip. To provide this unique visual effect in accordance with the current invention, the nozzle may be rotated upward at or around the same time of an abrupt increase in water pressure, though this upward motion need not occur. Immediately after the increase in water pressure, the nozzle may be abruptly lowered. In this manner, the water segment assumes momentum that causes it to flip backward as it distances itself from the nozzle.

Though not shown in the figures, a non-parabolic water stream that undergoes a front flip may also be produced according to the current invention. Here, the water pressure may be abruptly increased and immediately thereafter, the nozzle may be moved upward.

More specifically, by changing the amount of force imparted on the water stream by the pressure from the nozzle and the contact force from the nozzle on the different portions of the same water stream as it exits the nozzle, an imbalance between the water particles in the front of the truncated stream and the water particles near the end of the stream is created causing rotation.

Besides changing water pressure and nozzle direction as discussed above, the non-parabolic visual effects may be enhanced by lighting devices which may provide color to the non-parabolic streams. Additionally, multiple nozzles may eject water at or around the same time, and multiple non-parabolic effects may be simultaneously displayed.

The current invention also includes the use of a stream interrupter in the nozzle. That is, the nozzle may be fitted with a device that abruptly ceases the flow of water being ejected from the nozzle. This may allow shorter segments of water stream to be produced which may be more easily manipulated. This may produce non-parabolic visual effects such water forms that transform in mid air into vertical straight rods through the methods explained above.

FIG. 3 shows another possible embodiment of display 10 in which a non-parabolic laminar stream in the shape of a “C” shape is produced. Closed loops may also be produced.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A water display, comprising:
a stream of water that is ejected from a water delivery device and that is converted to non-parabolic form by a change in water pressure and change in direction of the water delivery device.

2. The water display of claim 1, wherein the non-parabolic form resembles a wave or a slack rope.

3. The water display of claim 1, wherein the non-parabolic form resembles a forward flip or back flip.

4. The water display of claim 1, wherein the change in water pressure or change in nozzle direction is abrupt.

5. The water display of claim 1, wherein the water delivery device is a nozzle.
